(19) United States
(12) Patent Application Publication
(10) Pub. No.: US 2025/0184442 A1
(43) Pub. Date: Jun. 5, 2025

(54) MULTI-FUNCTIONAL SELF-SERVICE MULTIMEDIA STUDIO FOR PRODUCING PHOTO/VIDEO MATERIALS

(71) Applicant: Igor Sergeevich LERNER, Yaroslavl (RU)

(72) Inventor: Igor Sergeevich LERNER, Yaroslavl (RU)

(21) Appl. No.: 19/051,908

(22) Filed: Feb. 12, 2025

Related U.S. Application Data
(63) Continuation-in-part of application No. 17/918,341, filed on Oct. 12, 2022, now abandoned.

(30) Foreign Application Priority Data
Oct. 6, 2020 (RU) 2020132794

(51) Int. Cl. H04N 5/222; H04N 23/56; H04N 23/698; H04N 23/90

(52) U.S. Cl. CPC H04N 5/222; H04N 23/56; H04N 23/698; H04N 23/90

(57) ABSTRACT

The proposed invention relates to the field of providing photographic services. An interactive system for processing and managing multimedia data comprises a set of interconnected technical elements arranged inside a housing having on its inside an adaptive surface that is connected with the equipment. The adaptive surface has a communicative effect on the images being formed, which, as a rule, are processed together with augmented reality components by means of software of at least one of the aforesaid technical elements. One of said elements is a smart unit with a processor for processing and subsequently distributing incoming signals generated by a user. Said signals are distributed among the other technical elements, the specifics of the operating process and mode of which are predetermined and are directed toward the realization, in accordance with a given algorithm.

### CROSS-REFERENCE TO RELATED APPLICATIONS

This patent application is a Continuation in part of the U.S. application Ser. No. 17/918,341 filed Oct. 12, 2022, which is a National stage application from PCT application PCT/RU2021/000395 filed Sep. 14, 2021, which claims priority to Russian patent application RU2020132794 filed Oct. 6, 2020.

### TECHNICAL FIELD

The present invention belongs to the field of photo services, and provides customer with ability of self-operating a photo/video recording process and obtaining professional-level digital images, which can later be displayed on a variety of electronic devices compatible with media files or as a hard copy in the form of prints on paper, images on clothes, souvenirs, etc.

### BACKGROUND OF THE INVENTION

The main obstacle faced by consumers when selecting provider of high-quality photo/video services is the difficulty in obtaining in one place various professional photo/video images including three-dimensional images used for various tasks, such as to obtain portraits, photographs for documents; panoramic photo/video images in three planes, required, for example, for creating digital models of a person; photo/video images for entertainment purposes, photo/video using augmented reality elements, etc. In most cases, consumers can access various listed services only in different locations, which inevitably leads to an increase in the time spent and an in higher costs.

In case of purchasing separately photo/video hardware that allows people to create photo/video images for various purposes, for example, a digital photo/video camera, several digital photo/video cameras, for creating combined images, rotary devices for taking images while rotating, printers of various formats, which are sold separately and which are not components of an integrated system, the consumer will face the difficulties of combining the listed devices into one system and the need for the help of a qualified person in order to obtain photo/video images designed to resolve the compatibility issues.

Also, for many users, simply connecting a group of devices through connecting cables is a problem. Connecting devices to work in different sequences and/or acted only partially for an ordinary consumer who is not a professional programmer or photographer/designer is a next to impossible task. In addition, creation of such images at home cannot match the quality of studio shooting with a professional photographer.

At the same time, it is important to note that a photo kiosk is known from the prior art (see FR3032284, class G03B17/53, publ. 2019).

Known technical solution belongs to the class of compact automatic photosystems operated by the customer in the self-service mode.

This kiosk is universal in autonomous operation, and can be installed both outdoors and indoors, for example, in a shopping mall or office business center.

The photo kiosk is made in the form of a compact body equipped with an input/output opening inside the body is a control unit with a payment terminal, a display for working with various applications and viewing images, a complex of photo/video cameras, lighting equipment, a rotary base mounted on shaft under which, as a rule, a device printing photographic images is installed.

The presented photo kiosk is a professional photo device and is capable of quickly producing high quality photographs, however, it is intended exclusively for the production of a strict format of photographs, which are mainly used for the production of digital or paper documents.

The system, due to the compact dimensions of the body, is quite simple and does not allow, for example, the use of photo/video equipment, in particular, for panoramic photo/video shooting or sequential photo/video shooting to obtain specific visual effects, in addition, there are no the possibility of pre-setting equipment operation modes, as well as image editing, which limits the use and narrows the range of consumer interest.

Also, an additional disadvantage can be considered that the known photo kiosk is not mobile and has to be installed permanently, so if it becomes necessary to move it from one area to another, it will be necessary to involve specialized equipment and staff, which complicates the operational process and increases the cost of maintenance.

An automatic 3D photo system is also known from the prior art (see KR101679398, class H04N13/00, publ. 2016).

The well-known 3D system is an interactive automatic self-service photo studio that has the ability to adaptively control photo/video equipment and systems and control the background during shooting, which allows one to create a variety of 3D volumetric images with their further fabrication using 3D printing devices.

This studio 3D photo system includes a separate cabin and a control block that controls the operational and software processes with a data storage subsystem and controls the main and auxiliary equipment, while in the mentioned cabin there are digital means for panoramic 3D photo/video shooting with an electric drive, as well as sensor elements.

According to the idea of a this well-known photo system, the specified storage subsystem contains information about the settings and modes of operation of the equipment, while the specified digital device for panoramic 3D photo/video shooting with an electric drive mechanism is made in the form of a mobile system of vertically installed rows of controlled video cameras, placement and combination which allows for 3D photo/video shooting, the results of which are transferred to the specified processing block, where they are processed and analyzed with further launch of the object printing process on a 3D printer.

The aforementioned mobile system of controlled video cameras providing digital 3D filming is made in the form of a technically sophisticated design in the form of an annular support base on the edge of which the racks are located in a circle, these racks move rectilinearly on power bridges, at the same time, the racks contain digital photo/video cameras installed one above the other, which are directed towards the working area of the cabin and have the ability to adjust their position in height.

It should be noted that the presented implementation of this system of controlled digital video cameras seems to be quite complicated in execution, in addition, the use of extended racks as holders of digital cameras are not capable of guaranteeing high image stabilization and, accordingly, the proper quality of images, since vibration transmitted from the mounting surface can be affected, and a rocking effect can also occur when the racks move with sudden stops.

An additional disadvantage in the operation of this known 3D photo system is the operational complexity of synchronizing the operation of a large number of photo/video cameras that are part of a single subsystem, since errors and delays can be observed during computer processing of simultaneously incoming digital information in an intelligent control block, the software of which, simulating a three-dimensional image of an object, must analyze the data of each camera, separately comparing the results with the data of other cameras, and in case of a malfunction or inaccurate operation of at least one digital camera, it becomes impossible to recreate an exact virtual 3D copy of an object.

Among other disadvantages of the known 3D photo system there is unreliability of the used for the system of controlled digital photo/video facilities, as well as expected failures and inaccuracies in run of the operating system of the intelligent control device.

The closest in terms of technical meaning to the present invention is an automatic multimedia photo/video system, known from U.S. Pat. No. 6,317,560, cl. GO3B15/OO, publ. 2001.

This multimedia system has the possibility of user selection of the photo/video shooting mode and synchronized equipment control, in particular, control of photo/video shooting systems, lighting equipment, and printing devices.

The well-known multimedia system's technical implementation is capable of creating conditions for shooting equivalent to the conditions inherent in a professional classical photo studio, and also provides simple and fast way for obtaining high-quality photo/video image.

The known automatic multimedia photo/video system contains a space equipped with an entrance/exit opening and a working area, bounded by side, top and bottom walls, inside the space there are lighting means of the working area, means of photo/video shooting, made with the ability to produce three-dimensional panoramic images, a display that allows to control the position of an object in real time, an additional complex of several photo/video devices, a device for printing the received digital images, as well as an electronic terminal with a control unit for controlling equipment functions and shooting modes.

It is possible to consider as a disadvantage of the known automatic multimedia photo/video system the insufficient interactive capabilities of this system, which in the absence of software and technical capabilities for advance programming of modes and options for equipment operation, in particular, photo/video recording systems, lighting systems, etc., the impossibility of automatic computer processing/correction of images directly in the shooting process, consisting, in particular, in the possibility of superimposing various virtual effects and elements of augmented reality, as well as the impossibility of additional software (artistic) editing of a photo/video image by the consumer and the impossibility of choosing the next option for materializing the digital image.

An additional disadvantage of the known automated multimedia photo/video system should be considered the limited communication capabilities of the employed equipment incapable of further improvement and not able to handle a superior amount of information materials and a set of software applications, including graphic editors that are used to obtain competitive and promising digital images used for both domestic use, and for professional use, for example, in the gaming industry and the motion picture industry.

Thus, the disadvantages of the well-known automatic multimedia photo/video system should be determined to be incapable of extension and competition.

### SUMMARY OF THE INVENTION

The purpose of the proposed invention is creation of a programmable intelligent media system designed to receive and display digital images, and having a convertible (flexible) operating structure with the necessary margin of functionality for further prospective modes of operations.

The technical result of the proposed invention, which is achieved when solving the specified technical problem, is to increase the functionality and technical level of the service provided, which consists in increasing the degree of automation of the performed operations and reducing the time for their integrated implementation, which is supported by consistently high degrees of interactivity and developing communication abilities.

The expected technical result and the specified technical solution are achieved by the fact that the interactive system for complex processing and management of multimedia data for obtaining an output digital image includes a set of interconnected technical objects each having a pre-programmed (built-in) and programmable functionality. These objects are placed in an environment adapted for the implementation of media capabilities, including a recording process for recording moving and/or still images. The environment is essentially limited by an interior space of a system housing, which on the inside has an adaptive surface in contact with the set of interconnected technical objects. The adaptive surface is configured to create a background for the resulting images which are processed, usually, with one or more augmented reality components and using software. The set of interconnected technical objects comprises a control smart unit comprising a processor that processes and subsequently distributes incoming control signals generated by a user or consumer through the dialog interface of an information input and output device also included in the smart control unit. At the same time, the distribution of the incoming control signals is carried out over the remaining technical objects, the features of the process and operation mode of which are established in advance and aimed at the implementation according to a certain algorithm of automatic static and/or moving photo and/or video shooting produced in the active area of the housing using a digital photo/video recording tool and a subsystem for creating a three-dimensional still and/or moving image. The subsystem comprises at least two digital photo/video cameras located one above another preferably in a vertical direction and configured to perform panoramic shooting in three planes during the recording process by using an Artificial Intelligence (AI) model. The AI model is implemented in the smart control unit and is part of the algorithm defined based on the incoming control signals. The AI model is configured to determine that the user or consumer freezes in a pose for a threshold time (e.g., at least 3 seconds) and cause the at least two digital photo/video cameras to perform the panoramic shooting. Preferably, the AI model is a neural network (e.g., Convolutional Neural Networks (CNN)) that is pre-trained based on a set of candidate poses, with the set of candidate poses including the pose in which the user or consumer freezes for the threshold time. The panoramic shooting is accompanied by the possibility of visual user's video control of the position in the active area of the housing in real time of the production of the media process, upon completion of which the media files received and processed in accordance with the algorithm enter the control smart unit, and the control smart unit further reproduces them in full format for the user or consumer for the purpose of their possible editing and a valid choice of digital image output option.

According to one of the preferred embodiments of the invention, the implementation of photo and/or video shooting takes place with the involvement of an additional digital photo/video recording device installed in the upper part of the housing with the possibility of axial rotation.

It is most expedient that photo and/or video filming takes place with the involvement of a subsystem for creating a volumetric image, made in the form of several digital photo/video cameras placed horizontally in a row on the front surface of the housing with the possibility of sequential shooting.

In the preferred embodiment of the invention, the implementation of photo and/or video shooting is running with the involvement of front, side and rear lighting.

According to one of the particular embodiments of the invention a digital photo/video recording device is placed in the area of the front surface of the housing on a vertically oriented movement system made in the form of a two-axis table with a movable carriage driven by electric motors.

It is also possible that a base rotary platform equipped with an electric drive for its movement is installed in the central supporting part of the space.

In some embodiments of the invention, the system is equipped with a stationary digital surveillance video camera.

According to the proposed invention concept, a new high-tech system provides the consumer with a full range of services related to obtaining a professional level and quality of photo and/or video services, comparable to the quality provided by professional photographers in comfortable and high quality studio conditions, moreover, the specified range of services covers the main functionality for obtaining moving or still photo and/or video materials in digital electronic form, as well as auxiliary functionality, which consists in the possibility of visualizing these materials on any compatible electronic devices, or their materialization, for example, on external printing devices, which in a fundamental sense is based on the principles of increasing the interactivity and intelligence of systems and the use of flexible electronic control structures capable of restructuring, which have the ability to successfully process constantly increasing volumes of information and apply non-standard and complex modes of operations, which in this proposed invention is systematically solved due to the presence of basic techniques that determine a set of interconnected technical objects that are capable of realizing the programmed and programmable potential and are located in a specially adapted media environment, the space is the media environment is limited by the housing which on the inside has an adaptive surface in contact with the equipment, this adaptive surface has a communicative effect on the resulting images, which processed, usually, with augmented reality components and using software, at least one of the mentioned objects, which is a control intellectual means with a processor, that processes and subsequently distributes incoming signals generated by the user through the dialog interface of the auxiliary interactive device for input/output of operational information, at the same time, the distribution of signals is carried out over the remaining technical objects, the features of the process and operation mode of which are established in advance.

According to the author's vision of the technical problem, reducing the time for the execution of the above-mentioned services, as well as increasing the level of automation of the operations performed, becomes possible due to the consolidation of the applied components inside the used media environment, the inner surface of which is adaptive and adapted to interact with the equipment used, such as programmable photo/video equipment and other auxiliary equipment. The equipment is controlled by the user. Also, the user determines the modes of operation that are carried out in one place and synchronize and organize interaction for a technological and operational solution of the task in accordance with the embedded software algorithms, which further provide and allow the possibility of additional custom graphic processing of images on the place with a technical choice of options for materialization of the obtained digital images.

An essential part of the concept is the inner surface of the housing that is in contact with the equipment and has adaptive capabilities that have a digital informational impact on the generated images. This, combined with the software processing, can create the most believable and realistic images that can be equipped with augmented reality components or other modern virtual changes that can make a significant contribution to the generated images with almost unlimited possibilities, expanding the technical kit, which allows to stand out functionally and use the received material not only for personal purposes, but also for professional ones.

An additional and most important feature is a high level of interactivity and responsive multimedia perception of the system, since the smart unit with the processor is used to control functional processes and interconnected equipment. The smart unit with the processor allows, through the dialogue interface of the auxiliary subsystem, to program the operating modes and determine the functionality of the equipment, to carry out the required processes of digital photo/video records according to the decision of the consumer, which allows shooting according to an individual scenario, this increases the functional level and service potential.

In addition to the above, the system is capable of real-time position corrections, as well as graphic processing of digital images in automatic mode according to the proposed users algorithm and processing in manual mode using graphic editors, with the subsequent possibility of choosing options for materializing images. It also provides increased information exchange and respectively, enhancing information awareness, which also increases functionality and positively affects the quality and variability of the resulting digital photo/video material.

Thus, the technique of complex processing and control of multimedia data presented above for obtaining an output digital image, taking into account its characteristics and technical features, forms a set of features sufficient to achieve the preassigned technical result, which is manifested by increased the level of automation of the operations performed and reduction of the time for their integrated implementation, which is supported by consistently high rates of interactivity and developing communicative ability, as well as to solve the specified technical problem of creating a programmable intelligent media system designed to receive and output digital images, and having a convertible (flexible) control structure with the necessary margin of functionality for further promising modes of operation.

### BRIEF DESCRIPTION OF DRAWINGS

FIG. 1. Interactive system for control and processing of multimedia data of generated digital images; A block diagram of one of the implementations is presented.

FIG. 2. Interactive system for control and processing multimedia data of generated digital images; an internal projection on one of the sides of the housing is presented.

FIG. 3. Interactive system for control and processing multimedia data of generated digital images; the general view of the option is presented.

### DETAILED DESCRIPTION OF THE INVENTION

The proposed Interactive system for control and processing multimedia data and generating digital images is illustrated by specific examples, which, however, are not the only possible ones, but clearly demonstrate the specified set of essential features provides the desired technical result as well as a solution to the specified technical problem.

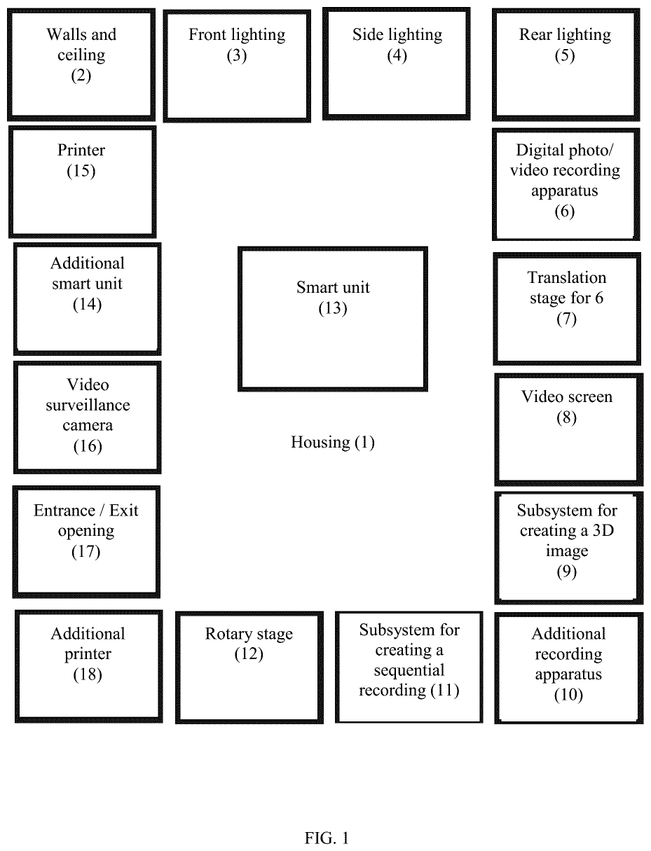

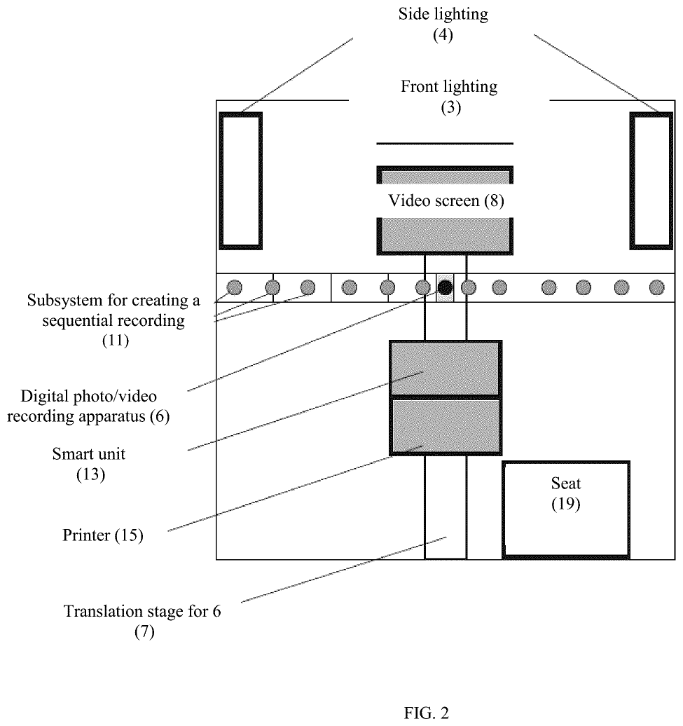

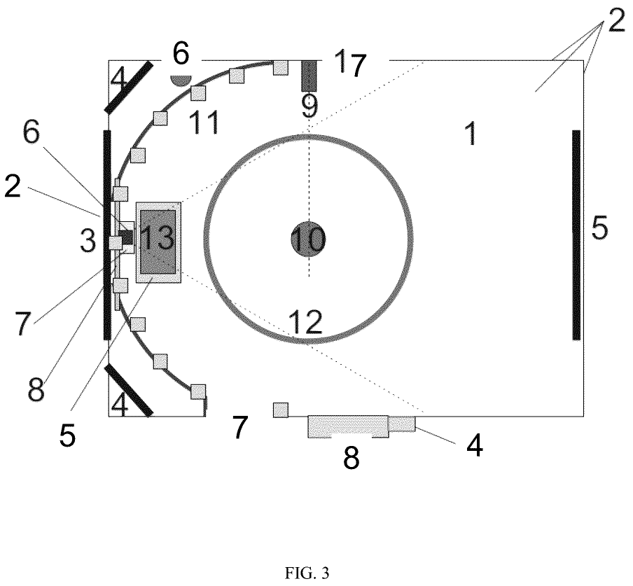

In FIGS. 1-3 the following parts and elements of the proposed Interactive system for managing and processing multimedia data are indicated:
1—housing;
2—walls and ceiling of the housing;
3—front lighting;
4—side lighting;
5—rear lighting;
6—digital photo/video recording apparatus;
7—translation stage for a digital photo/video recording apparatus 6;
8—video screen;
9—subsystem for creating a three-dimensional static and/or moving image;
10—supplementary digital photo/video recording apparatus;
11—subsystem for creating a three-dimensional image, performing photo/video, recording sequence;
12—rotating stage;
13—smart control unit with processor and payment sensor;
14—additional smart unit with processor and payment sensor;
15—multifunction printer;
16—stationary digital video camera for video surveillance;
17—entrance/exit opening;
18—additional multifunctional printer;
19—seat.

So, the proposed Interactive system for control and processing multimedia data of generated digital images includes a set of interconnected technical objects that realize programmed and programmable functionality.

The listed technical objects are located in an environment intended for the implementation of media capabilities, the volume of which is limited and indicated by a housing 1. The media capabilities include, in particular, the recording of moving and/or still images.

The housing 1 is similar to a separate room or cabin or kiosk and has an adaptive surface on the inside that is in contact with the equipment, which is capable of exerting a certain communicative influence on the images being formed.

An adaptive surface is understood as a surface that is capable and technically adapted to be some kind of auxiliary tool for taking photos or videos, i.e. be a background or act as a background or imitate various objects, as well as create surroundings that are typical for professional photo studios.

Also, an adaptive surface can consist of various elements, which, in turn, can be both stable and not change their state, creating a constant background during photo/video recording, or change this state in order to add various effects and images in the background obtained by the photo and video materials.

Including the adaptive surface can be changed (adapted) with the help of equipment, depending on the photo/video recording mode selected by a user.

As a rule, the inner surfaces of the housing 1 have matte, anti-reflective or monochrome colors.

In addition, this adaptive surface may have a kind of grid of horizontal and vertical lines to help to improve the orientation of the programmed photo/video recording algorithms, located, as a rule, opposite the digital photo/video recording apparatus 6.

Said contact with the equipment implies the direct installation of the equipment, in particular, on the surface of the housing 1 and its adjustment to operate in the relevant specific conditions.

As already mentioned, the adaptive surface of the housing 1 can also have a communicative effect on the created images, which should be understood as the ability to create recording conditions that ensure the transfer and exchange of information, as well as its perception during the recording process and after its completion.

According to the concept, the created images can be processed with augmented reality components, which is possible due to the use of an operating system, the software is capable of such processing and making corresponding virtual changes with signs of information augmentation of initially real images.

As already mentioned above, a group of interconnected technical objects is located in housing 1 and consists of the following:

One of the objects is a smart control unit 13 with a processor that controls all the processes of the interactive system, and its software, as indicated earlier, implements the processing of digital images, and actually processes and subsequently distributes the incoming signals generated by the user at the individual discretion, through the dialog interface of the auxiliary interactive input/output device of operational information.

Further distribution of signals is carried out among the remaining technical units, the features of the process and operation mode of which are established in advance and aimed at the implementation of automatic static and/or moving photo and/or video recording according to a certain algorithm or maintaining its modes, produced in the active area of the housing 1.

The control signals are fed into the digital photo/video recorder 6, a digital photo/video camera placed, as a rule, in the area of the front inner surface of the housing 1 on a vertically oriented movement system 7 (translation stage). This stage is capable of changing the focus of the device and is arranged like a two-coordinate table (carriages with electric drives) or rails along which a digital photo/video recording device fixed by a system of magnets moves with the help of electric motors 6. This equipment is protected, as a rule, by anti-vandal glass of a high level of transparency.

The control signals enter the subsystem 9 for creating a three-dimensional static and/or moving image, which is usually installed in the area of the side inner surfaces of the housing 1 and is made in the form of at least two digital photo/video cameras located one above the other, preferably in a vertical direction with the possibility of performing panoramic shooting, mainly in three planes. Said panoramic shooting is preferably performed using an Artificial Intelligence (AI) model that may be implemented in the smart control unit 13 and may be part of the algorithm defined based on the control signals. The AI model is configured to determine that the user freezes in a pose for a threshold time (preferably, at least 3 seconds) and cause the at least two digital photo/video cameras to perform the panoramic shooting. Preferably, the AI model is implemented as a neural network (NN) that is pre-trained based on a set of candidate poses, with the set of candidate poses including the pose in which the user freezes for the threshold time. Thus, the input data for the NN is a set of images/poses that may take, for example, the form of a four-dimensional array (packet size, height, width, depth). The NN may be trained using the back propagation method. Optionally, the NN may be trained based on the set of candidate poses combined with changes in the user's gaze direction.

In one exemplary embodiment, the AI model used to recognize the user poses is a Deep Learning AI model, such as one or more Convolutional NNs (CNNs) used to process images, videos and other 2D data. For further augmentation of the image obtained after capturing, a Generative AI model may be used, such as one or more Generative Adversarial Networks (GANs) which use a dual-network architecture of generators and discriminators to improve each other. The GAN(s) may be also implemented in the smart control unit 13. The GAN processes the image based on the task at hand, which may be then offered to the user for further processing or to choose from.

As an alternative to the above-described AI technology, a start button may be used in the system to initiate the panoramic shooting with the at least two digital photo/video cameras. For example, such a button may be implemented as a manual button connected to the at least two digital photo/video cameras by a wire. As one other alternative, the panoramic shooting may be initiated by means of voice start without having to use any (manual) button; in this case, the system may be additionally provided with voice recognition means configured to receive and interpret user voice commands (e.g., the system may comprise a microphone or any other device configured to record or capture an audio input comprising a corresponding voice command from the user and transmit it to the smart control unit 13 to further recognize the voice command using a specific AI model, such as a properly trained NN).

The control signals are also transmitted to the lighting control units, which are subdivided in housing 1 into front lighting 3, side lighting 4, and rear lighting 5.

The control signals can also be distributed to the control unit of the rotary rotating stage 12, which is installed on the surface in the center of the space of the housing 1 and is equipped with a rotation mechanism. The user or object is placed in the center of the rotating stage 12. The base part of the platform is marked with markings, and as the platform rotates, the process of photo/video recording takes place.

The control signals can come to an additional supplementary digital photo/video camera 10, which is installed, as a rule, on the ceiling 2 of the housing 1 and is a photo/video camera capable of rotating 360° and shooting in such a rotary mode.

Control signals can come to the subsystem 9 for creating a three-dimensional image, which performs sequential photo/video recording 11. This subsystem 9 is preferably located on the front surface of the housing 1 and consists of several digital photo/video cameras (3-36 pcs.), located along one horizontal line and allowing sequential photo/video recording radially along the line 175-185°. Using the software of the smart control unit 13, it is possible to perform sequential shooting by each camera with a given time interval in turn or in another sequence necessary to create a specific photo/video effect. In this case, the object or user is placed in the active area of the housing 1 and, depending on the type of recording set in advance, the process of photo/video recording by the specified digital photo/video cameras takes place. In this case, it is possible for the user or object to remain in place or it is possible to rotate by means of the rotating stage 12.

The photo/video capabilities described above can be implemented individually or in combination with each other, depending on the algorithm preselected by the user. At the same time, the processes are accompanied by the possibility of visual user video control of the position in the active area of the housing 1 in real time of the production of the media process, which is possible through the video screen 8.

It is also possible to monitor the ongoing processes inside the housing 1 in real time using a stationary digital video surveillance camera 16.

At the end of the photo/video process, the saved (received) and processed media files, in accordance with the algorithm, enter the smart control unit 13. Which reproduces digital images in full format for the consumer for the purpose of possible additional program editing, as well as a valid choice of digital image output option through a multifunction printer 15, which can print color images, 3D models, etc.

The proposed interactive system can be equipped with an additional smart unit 14 with a processor, which is located outside the housing 1.

At the same time, the main smart control unit 13 and additional unit 14 are usually equipped with service payment terminals.

The interactive system may be equipped with an optional professional multifunction printer 18 which is located outside the housing 1 and is capable of printing large format images as well as large format 3D models.

The housing 1 of the interactive system has an entrance/exit opening 17.

It should be noted that the purpose of the present description of the present invention is not to limit it to a specific embodiment and implementation option. On the contrary, in the scope of all possible additions that do not go beyond the scope of the presented claims.

The proposed Interactive system for control and processing multimedia data of generated digital images is integrated as follows.

The user enters the housing 1 through the opening 17 and uses smart control unit 13 with a processor and a payment sensor. Using its touch screen (information input/output device) and operating system with software, the user selects the type of photo/video recording from the available options or programs the operating modes independently, depending on the system configuration. Next, he adjusts the lighting (color, intensity, brightness, etc.), the background as he wishes, then the user creates the surroundings, selects the modes and operating conditions of the digital photo/video recording apparatus 6, the modes and operating conditions of the subsystem 9 for creating a three-dimensional image, adjusts the filters, and all sorts of additional effects and features are also modeled and/or created.

In a separate use case, the user has the ability to adjust the brightness, color, direction, color temperature of lighting means 3, 4 and 5, the location of the digital photo/video recording apparatus 6 in height, the focal length of the digital photo/video recording apparatus 6, the position of the subsystem 9 for creating a three-dimensional image with the choice of its numerous modes of operation, it is possible to choose the desired angle, etc.

Therefore, the user, with the help of the touch screen (information input/output device) of the smart control unit 13 and the software of its processor, selects the photo/video shooting mode, for example, the modes proposed by the program or visual modes and effects set and self-defined by the user, in particular, photo or video parameters, background, environment, for example, city landmarks, famous places or other background images, etc. are selected from the database of the smart control unit 13.

After completing the selection of all the necessary settings and the implementation of all preliminary operations, the user, through the smart control unit 13 with a processor and a payment sensor, starts the process of photographing/creating digital video, while clear instructions are indicated to the user on the touch screen and/or on the video screen 8, in particular, for example, a countdown to the first photograph can be shown.

The resulting digital images produced by the digital photo/video camera 6 and the subsystem 9 for creating a three-dimensional static and/or moving image are simultaneously displayed on the video screen 8, so that the user sees his position in real time and thereby adjusts his position for the best result.

At the end of the countdown, the smart control unit 13 with processor beeps one second before shooting, after which an action (digital picture or digital video process) is performed, as a result of which the result is sent to the smart control unit 13, which displays the result on the touch screen or video screen 8 and the countdown to the next automatic action starts, so the user has the opportunity to change position and change the moments that he did not like, then the next action (digital picture or digital video process) occurs, which can be repeated cyclically, for example, up to 10 times.

After the 10th shot, the smart control unit 13 with processor shows the user a message on the touch screen that all shots (actions) have been taken and the selection and possible editing of the images has to be started.

To do this, the smart control unit 13 with the processor shows the user potential edited digital images on the touch screen, the user selects the desired images, then the following menu appears on the screen, allowing further editing the characteristics of the images.

Additional custom editing of photo or video materials means the use of auto-filter, retouching, inscription, it is also possible to select a musical sequence for overlaying on digital video and much more.

After editing digital images, the user confirms the end of the process by pressing the desired area in the menu on the touch screen, after which the selected images are stored in the database of the smart control unit 13 with a processor, while the menu provides the ability to instantly send images to the consumer's e-mail and the ability to instantly print digital photos on multifunctional printers 15 and 18 in the format of flat photos or three-dimensional 3D models, etc.

The proposed interactive system for control and processing multimedia data of generated digital images can be successfully used in the field of professional photo services and can be installed both independently and indoors, for example, in a shopping center.

The appearance of such a system can be made in the form of a photo camera or video camera, which allows to draw the attention of users as to a photo-video studio and distinguish it from other objects, indicating its purpose.

The proposed object can be made with the possibility of movement or installed on a vehicle that has the ability to move.

Using the proposed Interactive system for control and processing multimedia data of generated digital images will allow any user to create a professional, high-quality photo or video very quickly and without the help of a photographer, and then, if necessary, without delay, share digital images on social media or print them on professional equipment that allows 3D printing.

1. An interactive system for complex processing and management of multimedia data for obtaining an output digital image, comprising:
a housing having an interior space defining an environment for implementation of media capabilities, the media capabilities including a recording process for recording moving and/or still images;
a set of interconnected technical objects each having a pre-programmed and programmable functionality, the set of interconnected technical objects being located in the environment;
wherein the housing has an adaptive surface in contact with the set of interconnected technical objects, the adaptive surface being configured to create a background for the moving and/or still images;
wherein the set of interconnected technical objects comprises at least one augmented reality component and a smart control unit, the smart control unit being configured to process the moving and/or still images with the at least one augmented reality component, the smart control unit comprising an information input and output device and a processor, the processor being configured to process and subsequently distribute incoming control signals generated by a consumer through the information input and output device to other technical objects of the set of interconnected technical objects;
wherein said other technical objects comprise a digital photo or video recording apparatus and a subsystem for creating a three-dimensional moving and/or still image which are configured to perform the recording process in the environment according to an algorithm defined based on the incoming control signals;
wherein the subsystem comprises at least two digital photo or video cameras located one above another in a vertical direction and configured to perform panoramic shooting in three planes during the recording process by using an Artificial Intelligence (AI) model, the AI model being part of the algorithm and configured to:
determine that the consumer freezes in a pose for a threshold time; and
cause the at least two digital photo or video cameras to perform the panoramic shooting;
wherein the AI model is a neural network that is pre-trained based on a set of candidate poses, the set of candidate poses including the pose in which the consumer freezes for the threshold time;
wherein said other technical objects further comprise a video screen configured to display, to the customer, a position of the consumer in the environment in real time during the recording process;
wherein the digital photo or video recording apparatus and the subsystem are further configured to provide the moving and/or still images resulted from the recording process to the smart control unit;
wherein the smart control unit is further configured, through the information input and output device, to reproduce the moving and/or still images in full format for the consumer and request the costumer to select the output digital image from the reproduced moving and/or still images; and
wherein the smart control unit is further configured, through the information input and output device, to display, to the customer, a menu for editing characteristics of the output digital image.

2. The interactive system according to claim 1, wherein said other technical objects further comprise an additional digital photo or video recording apparatus installed in an upper part of the housing and configured to perform an axial rotation, and wherein the digital photo or video recording apparatus, the additional digital photo or video recording apparatus and the subsystem are configured to jointly operate during the recording process in the environment.

3. The interactive system according to claim 1, wherein said other technical objects further comprise an additional subsystem for performing sequential photo or video recording, the additional subsystem comprising several digital photo or video cameras placed on the adaptive surface of the housing horizontally in a row, and wherein the digital photo or video recording apparatus, the subsystem and the additional subsystem are configured to jointly operate during the recording process in the environment.

4. The interactive system according to claim 1, further comprising a front lighting means, a side lighting means and a rear lighting means which are configured to control front lighting, side lighting and rear lighting, respectively, based on the incoming control signals during the recording process in the environment.

5. The interactive system according to claim 1, wherein the digital photo or video recording apparatus is placed in an area of the adaptive surface of the housing on a vertically oriented movement system that is configured as a two-coordinate table including a movable carriage driven by electric motors.

6. The interactive system according to claim 1, further comprising a landing rotary platform installed in a center of the interior space of the housing, the landing rotary platform being equipped with an electric drive.

7. The interactive system according to claim 1, further comprising a stationary digital video surveillance camera inside the housing.
